(19) United States
(12) Patent Application Publication
(10) Pub. No.: US 2016/0017094 A1
(43) Pub. Date: Jan. 21, 2016

(54) Ring Opening Of Oxazolines At High Temperature In A Continuous Process

(71) Applicant: BASF SE, Ludwigshafen (DE)

(72) Inventors: Jon A. Debling, Saline, MI (US); David Trumbo, Wyandotte, MI (US)

(73) Assignee: BASF SE, Ludwigshafen (DE)

(21) Appl. No.: 14/774,043

(22) PCT Filed: Mar. 12, 2014
(86) PCT No.: PCT/US14/24264

§ 371 Date: Sep. 9, 2015

Related U.S. Application Data
(60) Provisional application No. 61/793,738, filed on Mar. 15, 2013.

(51) Int. Cl. C08G 69/00

(52) U.S. Cl. CPC C08G 69/00

(57) ABSTRACT

A process for preparing a polyoxazoline includes feeding continuously an oxazoline, a solvent, and a catalyst to a continuous stirred tank reactor at a rate which provides for a residence time sufficient to achieve ring opening of the oxazoline and polymerize the oxazoline; exiting a polyoxazoline solution from the continuous stirred reactor, the polyoxazoline solution including polyoxazoline, solvent, and, optionally, unreacted oxazoline, low molecular weight oligomeric oxazoline, or a mixture thereof; removing the solvent, and, optionally, unreacted oxazoline, low molecular weight oligomeric oxazoline, or a mixture thereof from the polyoxazoline solution; and recovering the polyoxazoline.

### FIELD

The present technology generally relates to polymer preparation. More specifically it relates to the preparation of polyoxazolines via a high temperature, continuous process.

### BACKGROUND

Oxazolines are compounds of general formula:

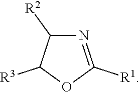

Soon after their discovery, it was discovered that oxazolines were readily polymerizable under mild cationic conditions, to high molecular weight materials. The polymerization proceeds via initiation by quaternization of the nitrogen atom of the ring, followed by opening of the oxazoline ring, and cationic propagation of the as illustrated in idealized Scheme 1.

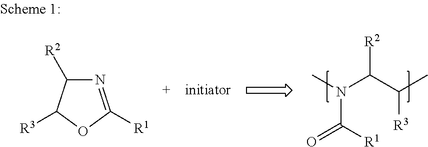

Unfortunately, the classical ways of producing polyoxazolines involve ring opening polymerizations at low temperatures (60-80° C.) and long batch times (6-8 hours) which makes the materials expensive, and time-consuming to produce.

### SUMMARY

In one aspect, a process is provided including continuously polymerizing in a reactor an oxazoline monomer at elevated temperature to form a polyoxazoline. In some embodiments, the elevated temperature is greater than 150° C. In any of the above embodiments, the reactor may include a continuous stirred tank reactor. In any of the above embodiments, the reactor may include a continuous loop reactor. In any of the above embodiments, the reactor may include a series of reactors including at least one continuous stirred tank reactor and at least one continuous loop reactor.

In any of the above embodiments, the polymerizing may include feeding continuously at least one oxazoline monomer and a catalyst to the reactor at a rate that provides for a residence time sufficient to achieve ring opening of the oxazoline and polymerize the oxazoline, wherein the reactor is maintained at a temperature from about 150° C. to about 250° C.; and exiting a polyoxazoline solution from the reactor, the polyoxazoline solution comprising polyoxazoline catalyst or catalyst fragments and, optionally, unreacted oxazoline, low molecular weight oligomeric oxazoline, or a mixture thereof. In any of the above embodiments, the process may also include feeding a solvent to the reactor with the oxazoline monomer and catalyst. In any of the above embodiments, the process may also include removing the solvent, and, optionally, unreacted oxazoline, low molecular weight oligomeric oxazoline, or a mixture thereof from the polyoxazoline solution; and recovering the polyoxazoline.

In any of the above embodiments, the at least one oxazoline monomer may be a compound of formula:

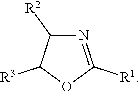

In the above formula, R¹ is H, F, Cl, Br, I, CN, NO₂, amino, alkyl, alkenyl, aryl, heteroaryl, or heterocyclyl. In the above formula, R² may be H, F, Cl, Br, I, CN, NO₂, amino, alkyl, alkenyl, aryl, heteroaryl, or heterocyclyl. In the above formula, R³ may be H, F, Cl, Br, I, CN, NO₂, amino, alkyl, alkenyl, aryl, heteroaryl, or heterocyclyl. In any of the above embodiments, R¹ is C₁-C₂₀ alkyl, C₁-C₂₀ alkenyl, C₆-C₁₈ aryl, or an oxazoline. In any of the above embodiments, R² may be H, CH₃, or phenyl. In any of the above embodiments, R³ may be H, CH₃, or phenyl. In any of the above embodiments, the oxazoline may be methyl oxazoline, ethyl oxazoline, propyl oxazoline, isopropenyl oxazoline, butyl oxazoline, phenyl oxazoline, undecyl oxazoline, dodecyl oxazoline, stearyl oxazoline, or a mixture of any two or more thereof.

In any of the above embodiments, the solvent may be a polar aprotic solvent, an ester, an ether, a ketone, or an aromatic. In any of the above embodiments, the residence time may be from about 1 minute to about 1 hour. In any of the above embodiments, the catalyst may be a weak Lewis acid, a strong protic acid, an alkyhalide, a benzyl halide, a substituted benzyl halide, a strong acid ester, or a mixture of any two or more thereof. In any of the above embodiments, the catalyst may be methyl-p-toluene sulfonic acid, or a salt thereof.

In any of the above embodiments, the temperature may be from about 180° C. to about 220° C. In any of the above embodiments, the temperature may be about 200° C. In any of the above embodiments, the solvent may be added at from greater than 0 wt % to about 50 wt %. In any of the above embodiments, a yield of polyoxazoline may be greater than 90%. In any of the above embodiments, a yield of polyoxazoline may be greater than 95%. In any of the above embodiments, a yield of polyoxazoline may be approximately quantitative.

In any of the above embodiments, the oxazoline, solvent and catalyst may be fed separately to the reactor. In any of the above embodiments, the process may also include dissolving the oxazoline in the solvent prior to feeding. In any of the above embodiments, the process may also include dissolving the oxazoline and catalyst in the solvent prior to feeding.

In another aspect, the polyoxazoline formed by any of the above processes is provided.

### DETAILED DESCRIPTION

The illustrative embodiments described in the detailed description and claims are not meant to be limiting. Other embodiments may be utilized, and other changes may be made, without departing from the spirit or scope of the subject matter presented here. The present technology is also illustrated by the examples herein, which should not be construed as limiting in any way.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

Heterocyclyl or heterocycle refers to both aromatic and nonaromatic ring compounds including monocyclic, bicyclic, and polycyclic ring compounds containing 3 or more ring members of which one or more is a heteroatom such as, but not limited to, N, O, and S. Examples of heterocyclyl groups include, but are not limited to: unsaturated 3 to 8 membered rings containing 1 to 4 nitrogen atoms such as, but not limited to pyrrolyl, pyrrolinyl, imidazolyl, pyrazolyl, pyridinyl, dihydropyridinyl, pyrimidinyl, pyrazinyl, pyridazinyl, triazolyl (e.g. 4H-1,2,4-triazolyl, 1H-1,2,3-triazolyl, 2H-1,2,3-triazolyl etc.), tetrazolyl, (e.g. 1H-tetrazolyl, 2H tetrazolyl, etc.); saturated 3 to 8 membered rings containing 1 to 4 nitrogen atoms such as, but not limited to, pyrrolidinyl, imidazolidinyl, piperidinyl, piperazinyl; condensed unsaturated heterocyclic groups containing 1 to 4 nitrogen atoms such as, but not limited to, indolyl, isoindolyl, indolinyl, indolizinyl, benzimidazolyl, quinolyl, isoquinolyl, indazolyl, benzotriazolyl; unsaturated 3 to 8 membered rings containing 1 to 2 oxygen atoms and 1 to 3 nitrogen atoms such as, but not limited to, oxazolyl, isoxazolyl, oxadiazolyl (e.g. 1,2,4-oxadiazolyl, 1,3,4-oxadiazolyl, 1,2,5-oxadiazolyl, etc.); saturated 3 to 8 membered rings containing 1 to 2 oxygen atoms and 1 to 3 nitrogen atoms such as, but not limited to, morpholinyl; unsaturated condensed heterocyclic groups containing 1 to 2 oxygen atoms and 1 to 3 nitrogen atoms, for example, benzoxazolyl, benzoxadiazolyl, benzoxazinyl (e.g. 2H-1,4-benzoxazinyl etc.); unsaturated 3 to 8 membered rings containing 1 to 3 sulfur atoms and 1 to 3 nitrogen atoms such as, but not limited to, thiazolyl, isothiazolyl, thiadiazolyl (e.g. 1,2,3-thiadiazolyl, 1,2,4-thiadiazolyl, 1,3,4-thiadiazolyl, 1,2,5-thiadiazolyl, etc.); saturated 3 to 8 membered rings containing 1 to 2 sulfur atoms and 1 to 3 nitrogen atoms such as, but not limited to, thiazolodinyl; saturated and unsaturated 3 to 8 membered rings containing 1 to 2 sulfur atoms such as, but not limited to, thienyl, dihydrodithiinyl, dihydrodithionyl, tetrahydrothiophene, tetrahydrothiopyran; unsaturated condensed heterocyclic rings containing 1 to 2 sulfur atoms and 1 to 3 nitrogen atoms such as, but not limited to, benzothiazolyl, benzothiadiazolyl, benzothiazinyl (e.g. 2H-1,4-benzothiazinyl, etc.), dihydrobenzothiazinyl (e.g. 2H-3,4-dihydrobenzothiazinyl, etc.), unsaturated 3 to 8 membered rings containing oxygen atoms such as, but not limited to furyl; unsaturated condensed heterocyclic rings containing 1 to 2 oxygen atoms such as benzodioxolyl (e.g., 1,3-benzodioxoyl, etc.); unsaturated 3 to 8 membered rings containing an oxygen atom and 1 to 2 sulfur atoms such as, but not limited to, dihydrooxathiinyl; saturated 3 to 8 membered rings containing 1 to 2 oxygen atoms and 1 to 2 sulfur atoms such as 1,4-oxathiane; unsaturated condensed rings containing 1 to 2 sulfur atoms such as benzothienyl, benzodithiinyl; and unsaturated condensed heterocyclic rings containing an oxygen atom and 1 to 2 oxygen atoms such as benzoxathiinyl. Heterocyclyl group also include those described above in which one or more S atoms in the ring is double-bonded to one or two oxygen atoms (sulfoxides and sulfones). For example, heterocyclyl groups include tetrahydrothiophene oxide and tetrahydrothiophene 1,1-dioxide. Typical heterocyclyl groups contain 5 or 6 ring members. Thus, for example, heterocyclyl groups include morpholinyl, piperazinyl, piperidinyl, pyrrolidinyl, imidazolyl, pyrazolyl, 1,2,3-triazolyl, 1,2,4-triazolyl, tetrazolyl, thiophenyl, thiomorpholinyl, thiomorpholinyl in which the S atom of the thiomorpholinyl is bonded to one or more O atoms, pyrrolyl, pyridinyl homopiperazinyl, oxazolidin-2-onyl, pyrrolidin-2-onyl, oxazolyl, quinuclidinyl, thiazolyl, isoxazolyl, furanyl, and tetrahydrofuranyl. Heterocyclyl or heterocycles may be substituted.

In one aspect, a process is provided for the high-temperature, continuous, cationic ring-opening polymerization (CROP) of oxazoline monomers. In the process, the monomers are continuously fed to a continuous stirred tank reactor (CSTR) and heated at high temperature, as the polymerization progresses the resulting polyoxazoline (POZ) is removed from the reactor and isolated. The feeding of the monomers to the CSTR is conducted a rate such that the residence time of the monomers in the reactor is sufficient to produce a POZ.

The POZ produced above may find wide-ranging use in a number of applications. For example, the POZs made by the high-temperature, continuous, polymerization process are useful as pigment dispersants for solvent borne pigment dispersions in coatings such as paints and inks, as precursors for antifouling coatings to prevent proteins and bacteria from adhering to surfaces such as, but not limited to, medical instruments, medical implants, or in marine applications, as adhesion promoters to surfaces including plastics, wood, concrete and metal, as emulsifiers for pharmaceutical and agricultural products, as adhesives for polymer films, as a hair fixative, and myriad other uses.

The process of preparing the POZs includes feeding continuously at least one oxazoline monomer to a continuous stirred tank reactor at a rate which provides for a residence time sufficient to achieve ring opening of the oxazoline and polymerize the oxazoline. The oxazoline may be accompanied by a solvent and/or a catalyst. The polyoxazoline, along with any added solvent, excess oxazoline monomer, oxazoline oligomers, and catalyst or catalyst breakdown products, is then exited from the reactor. Volatile components such as the solvent, excess oxazoline monomer, and possibly small oxazoline oligomers, may be removed under vacuum. The POZ may then be recovered.

As noted, the process is a high-temperature process. Accordingly, the reactor may be maintained at a temperature and for a time period that is sufficient to polymerize the oxazolines. For example, the temperature may be from about 150° C. to about 250° C. In other embodiments, the temperature may be from about 180° C. to about 220° C. In some embodiments, the temperature is about 200° C.

As used herein, the term oxazoline oligomer refers to small polyoxazolines of from 2 to about 20 repeat units. Due to the smaller mass of such oligomers, some may be relatively volatile upon application of a vacuum.

In some embodiments, the method includes feeding continuously at least one oxazoline monomer, a solvent, and a catalyst to a continuous stirred tank reactor at a rate which provides for a residence time sufficient to achieve ring opening of the oxazoline and polymerize the oxazoline. The polyoxazoline is then isolated by continuously removing solution from the reactor, the solution including the POZ, excess oxazoline monomer, oxazoline oligomers, and catalyst or catalyst breakdown products, and exposing the solution to a vacuum to remove the volatile components.

As noted above, the process includes the polymerization of at least one oxazoline monomer. Mixtures of any two or more oxazoline monomers may be used in the process to provide POZs having a wide range of solubilities, glass transition temperatures (Tg), and other properties. In addition, because the polymerization process is considered to a “living polymerization,” the use of multiple reactors in sequence allows the addition of different oxazoline monomers to different parts of the process such that block polyoxazolines (bPOZ) are formed. In living polymerizations, the polymerization of the monomer progresses until the monomer is virtually exhausted. Upon addition of further monomer or a different monomer, the polymerization resumes. Where different monomers are used, this may result in blocks of the polymerization product of each type of monomer that is added to the reactor. In living polymerizations, the degree of polymerization, and hence the molecular weight, is controlled by the monomer and initiator concentrations. This allows for the synthesis of well-defined species with a narrow molecular weight distribution, as well as block polymers with controlled block lengths.

The oxazoline monomers that are used in the process may include additional polymerizable groups such as olefin, or acrylate substituents on the oxazoline ring. Upon CROP of the oxazoline, the olefin or acrylate substituent may be preserved as a pendant group on the resulting POZ, allowing for additional polymerization sites or for cross-linking of the POZ, post-ROP process. Alternatively, the additional polymerizable group may be activated in the CSTR to provide for cross-linked POZs of higher molecular weight. Such polymerizable groups, for example olefins, may provide for an olefinic POZ that is activated by UV light for curing.

In the process, selection of appropriate monomer(s), operating temperatures, residence time and molar ratio of monomer(s) to catalyst, may result in a desired polymer composition and molecular weight. Normally, higher molar ratios of monomer(s) to catalyst leads to higher molecular weight. In addition, increasing residence time has the effect of leading to higher molecular weights at equal molar ratio of monomer(s) to catalyst. However, molecular weight is highly dependent on the mode of chain termination. Termination of the living chains can be from, but is not limited to, monomers, solvents or impurities such water in the feed to the reactor. In addition, the nature of the reactor(s) configuration, and, thus, residence time distribution, has an effect on the molecular weight and molecular weight distribution of the polymer. Fully backmixed processes, such as the CSTR, tend to produce polymers with broader molecular weight distributions. For example, higher ratios of monomer to catalyst in the feed mixture may produce higher molecular weight polymers, or lower ratios of monomer to catalyst may produce lower molecular weight polymers.

Suitable oxazolines for use in the process include a wide variety of such materials. In one embodiment, the at least one oxazoline monomer is a compound represented as Formula I:

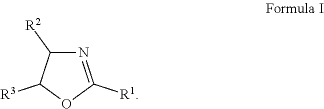

In Formula I, R¹ may be H, F, Cl, Br, I, CN, NO₂, amino, alkyl, alkenyl, aryl, heteroaryl, or heterocyclyl. In Formula I, R² may be H, F, Cl, Br, I, CN, NO₂, amino, alkyl, alkenyl, aryl, heteroaryl, or heterocyclyl. In the above Formula I, R³ may be H, F, Cl, Br, I, CN, NO₂, amino, alkyl, alkenyl, aryl, heteroaryl, or heterocyclyl. In some embodiments, R¹ is C₁-C₂₀ alkyl, C₁-C₂₀ alkenyl, C₆-C₁₈ aryl, or an oxazoline. In any of the above embodiments, R² may be H, CH₃, or phenyl. In any of the above embodiments, R³ may be H, CH₃, or phenyl. The R¹ groups may include all alkyl groups, they may be based upon fatty acid linkages with saturation or one or more sites of unsaturation, ether-based groups such as ethylene glycol, propylene glycol, butylene glycol, or polymeric groups of any of these (e.g. polyethylene glycol groups), or ester based groups with alkyl attachment to the oxazoline ring. Illustrative oxazolines include, but are not limited to, methyl oxazoline, ethyl oxazoline, propyl oxazoline, isopropenyl oxazoline, butyl oxazoline, phenyl oxazoline, undecyl oxazoline, dodecyl oxazoline, and stearyl oxazoline. As noted above, any two or more of such oxazolines, generally or specifically, may be used to prepare POZ co-polymers from a mixture, or POZs when used sequentially in the reactor, or in a series of reactors. Additionally, oxazolines may be polymerized in the presence of a second oxazoline monomer, selected from the above oxazolines, to form a block co-polymer.

Suitable catalysts for use in the process may also take a wide variety of forms, but they should be effective to catalyze the ROP of the oxazoline monomers. Suitable examples include strong electrophiles. For example, the catalyst may generally be a weak Lewis acid, strong protic acid, an alkyhalide, a benzyl halide, a substituted benzyl halide a strong acid ester, or a mixture of any two or more such catalysts. Illustrative catalysts include, but are not limited to, methyl-p-toluene sulfonate, methyl-p-toluene sulfonic acid (MTSA); bismuth salts such as BiCl₃, BiBr₃, BiI₃, and bismuth triflate; benzyl chloride, benzyl iodide, and benzyl bromide.

The molar ratio of the oxazoline to catalyst should be sufficient to achieve a reasonable rate of reaction in the CSTR and form a sufficient polymer molecular weight. In some embodiments, the molar ratio of catalyst:oxazoline is from about 1:25 to about 1:400. In some embodiments, the molar ratio of catalyst:oxazoline is from about 1:85 to about 1:150. In one embodiment the molar ratio of catalyst:oxazoline is about 1:100.

The solvent, when used in the process, dissolves the monomers for efficient polymerization, and may solubilize or suspend the catalyst(s) and POZs that are formed. The solvent will also have an operating temperature that is compatible with the high-temperature process and be stable in the presence of the monomers and catalysts. Generally, the solvent may be a polar aprotic solvent, an ester, an ether, a ketone, or an aromatic solvent. Illustrative solvents include, but are not limited to, methyl amyl ketone (MAK), methyl iso-butyl ketone, acetone, methyl ethyl ketone, xylene, Aromatic 100, and Aromatic 150. The solvent can be present in levels ranging from 0 to about 50 wt % of the ingredients continuously charged to the process. In some embodiments, the amount of solvent is from greater than 0 wt % to about 50 wt %. Mixtures of solvents are possible yet the process may also be optionally run in the absence of solvent.

As introduced above, the rate of feed of the monomers is conducted at a rate such that the residence time in the CSTR is sufficient for polymerization of the oxazoline to occur. The residence time may range from about 1 minute to 1 hour. In some embodiments, the residence time is from about 5 minutes to about 1 hour. In other embodiments, the residence time is from about 1 minute to about 45 minutes. In other embodiments, the residence time is from about 1 minute to about 30 minutes. In other embodiments, the residence time is from about 5 minutes to about 15 minutes. In other embodiments, the residence time is from about 15 minutes to about 30 minutes.

To achieve such a residence time, the feed rate of the monomer, solvent, and catalyst may be varied, or the level in the reactor adjusted. In the process, the oxazoline, solvent, and catalyst may be fed separately to the continuous stirred tank reactor, or in any combination. For example, in some embodiments, the process includes adding the oxazoline, monomer, and catalyst in separate feed streams. In other embodiments, the process includes dissolving the oxazoline in the solvent prior to feeding. In other embodiment, the process includes dissolving the oxazoline and catalyst in the solvent prior to feeding.

The conversion yield of oxazoline to polyoxazoline may be adjusted to about 100%. In some embodiments, the yield of polyoxazoline, based upon added oxazoline is at least 90%.

A suitable reactor that is used in the process is a continuous stirred tank reactor. Other suitable reactors include loop reactors, extruders, or other reactor configurations that are configured for continuous operation, and continuous movement and/or agitation of the reactor contents. Such reactors are described in U.S. Pat. No. 6,552,144. The process may also include cascades of reactors in series configurations. For example, a series of 2, 3 or more CSTR's may be aligned so that the product from one CSTR is charged to the next and so on. In such as manner, the residence time and residence time distribution of the process can be adjusted to tailor the molecular weight distribution of the polymer product.

In the process, the monomers, solvents and catalysts may be optionally purified to remove residual “chain terminators” such as water. This may be performed inline continuously or in a separate batch step. Accordingly, in some embodiments the monomer, solvent, and/or catalyst is substantially free of water. As used herein substantially free of water refers to a material that is either free of water, or has a very low water content. For example, substantially free of water may be less than 1 wt % water, less than 0.1 wt % water, or less than 0.01 wt %. In some embodiment, substantially free of water means less than 0.01 wt % water. The only water that is present is adventitious water in the materials such as the monomers, catalysts, or solvents. Removal of such water, and other impurities, avoids, or at least minimizes chain terminating reactions. However, if chain termination is desired, water may be purposefully added at an appropriate ratio of water to monomer.

In the process, the polyoxazoline leaving the process may be optionally terminated to control molecular weight or functionalize the polymer. Suitable termination agents include, but are not limited to water, alcohols and acids. Examplary termination agents include methanol, ethanol, acrylic acid and methacrylic acid. The termination agents may be added to the polyoxazoline prior to or after removal of the volatile components by vacuum.

As noted above, the molecular weight averages of the POZs, may cover a wide range, with higher concentrations of oxazoline and/or catalyst resulting generally in higher molecular weight POZs. In some embodiments, the weight average molecular weight (M_{w}) of the POZs may be from about 1,500 g/mol to about 30,000 g/mol. In some embodiments, the M_{w} of the POZs may be from about 5,000 g/mol to about 15,000 g/mol. In some embodiments, the number average molecular weight (Mₙ) of the POZs may be from about 1,000 g/mol to about 20,000 g/mol. In some embodiments, the Mₙ of the POZs may be from about 5,000 g/mol to about 10,000 g/mol.

In another aspect, the POZs as prepared above may be used as additives or coatings, inks or adhesives, solvent and waterborne dispersants for pigments, hot melt adhesives, protective colloids for emulsion polymerization, emulsifiers for pharmaceuticals, emulsifiers for agricultural products, primers, precursors for antifouling materials, compatibilizers for plastics, glass fiber sizing agents, cosmetics, water treatment agents, a hair fixatives, chelant for metal ions, or as lubricants.

In another aspect, coating formulations of the POZs are provided. The formulations include dissolution or suspension of the POZ in a solvent, where the POZ is a dispersant for a pigment. The coating formulations may also contain a binder. In some embodiments, the coating formulation is an ink formulation.

The coating formulations may include a wide range of other additives such as, but not limited to, surfactants, biocidal agents; drying agents; pigments; fillers such as a clay, calcium carbonate, and the like; defoamers; wetting agents; light stabilizers; surface-active agents; thickeners; and pigment stabilizers. As used herein, biocidal agents are materials that prevent or inhibit the growth of bacteria, viruses, fungi, or other biological fouling agents in the emulsions or products prepared with or from such formulations. As used herein, drying agents, are materials added to a coating to enhance the drying speed of the coating. As used herein, light stabilizers prevent, or minimize, degradation of the polymers by exposure to various light sources, including ultra violet light. As used herein, surface-active agents are materials that are added to the coating in order to stabilize coatings. As used herein, thickeners are materials that are added to the coating to increase the viscosity of the emulsion. As used herein, pigment stabilizers are materials that are added to stabilize a pigment from fading and degradation.

In another aspect a coating is provided that includes the any of the POZs or prepared POZs, described above. The coating may be a paint, an ink, primer, sizing agent, overprint varnish, or other like coating.

Such coatings may, of course, be applied to a substrate. Illustrative substrates include, but are not limited to, plastic, wood, concrete, ceramics, and glass. For example, the substrate may include, but is not limited to, flexible plastic packaging, polypropylene, polyethylene, treated plastic, polycarbonates, treated or oxidized polypropylene, treated or oxidized polyethylene as substrates, and the like.

The POZs may find application in the pharmaceutical, adhesives, surfactants, coating, ink and many other fields. For example, polyoxazolines may be utilized as adhesion promoters and adhesives for a variety of substrates including glass, plastic, wood, metal and concrete. POZs have been used to glue polypropylene to polypropylene to make trash bags. The nature of the POZ backbone makes these materials adhere very well to metal and, as such, the polymers provide superior corrosion resistance. In addition, because the nature of the R (or R′) group can vary widely, side chains that increase adhesion may be incorporated.

The POZs may be melt blended with a variety of polymers including, but not limited to, polyethylene, polypropylene, polyethylene•acrylic acid, polystyrene, polyethylene terephthalates, acrylics, and the like. Generally, the blends display increased durability in terms of environmental resistance, improved scratch resistance, improved cut resistance, and improved pigment dispersion.

The present technology, thus generally described, will be understood more readily by reference to the following example, which is provided by way of illustration and is not intended to limit the present technology.

### EXAMPLES

### Example 1

Polyoxazolines are prepared by high temperature, ring-opening polymerization in a continuous stirred tank reactor (CSTR). The ethyl oxazoline (EOZ), methyl amyl ketone, and methyl-p-toluene sulfonate (MPTS) is mixed in a vessel until a clear solution is obtained to form the feed solution. The feed solution is then continuously introduced to a 100 ml CSTR at a rate sufficient to maintain a 12 minute residence time in the reactor. The product is then continuously removed from the reactor and subjected a vacuum to remove the solvent and excess monomer. The solvent and excess monomer is condensed and recovered. After a steady state is achieved, the polymer sample is collected. Gas chromatography may be performed on the recovered solvent and excess monomer and the polymer sample to determine the amount of free solvent and monomer. Conversion of the ethyl oxazoline to form polymer may be computed by a mass balance. Illustrative feed component ratios and reactor conditions are shown in Table 1. For all samples, a total conversion of over 90% of the ethyl oxazoline is obtained.

TABLE 1
Feed and Reaction Conditions for POZ Preparation.

| | Sample | | | | | | | | | |
|---|---|---|---|---|---|---|---|---|---|---|
| | 1 | 2 | 3 | 4 | 5 | 6 | 7 | 8 | 9 | 10 |
| Residence | 12 | 12 | 12 | 12 | 12 | 12 | 12 | 12 | 12 | 12 |
| Time (min) | | | | | | | | | | |
| Temperature | 200 | 200 | 200 | 200 | 200 | 200 | 200 | 210 | 190 | 180 |
| (° C.) | | | | | | | | | | |

Feed

| | | | | | | | | | | |
|---|---|---|---|---|---|---|---|---|---|---|
| Ethyl | | | | | | | | | | |
| Oxazoline | 20.86 | 41.71 | 62.57 | 83.43 | 83.43 | 83.20 | 84.00 | 83.43 | 83.43 | 83.43 |
| (EOZ; wt %) | | | | | | | | | | |
| MPTS (wt %) | 0.39 | 0.79 | 1.18 | 1.57 | 1.57 | 1.80 | 1.00 | 1.57 | 1.57 | 1.57 |
| MAK (wt %) | 78.75 | 57.50 | 36.25 | 15.00 | 15.00 | 15.00 | 15.00 | 15.00 | 15.00 | 15.00 |
| Mol Ratio of | | | | | | | | | | |
| EOZ:MPTS | 100.48 | 99.19 | 99.62 | 99.83 | 99.83 | 86.84 | 125.87 | 99.83 | 99.83 | 99.83 |

### Example 2

Characterization of the polymer samples of Example 1. The polymers may be applied to a gel permeation chromatograph (GPC) using dimethyl acetamide as the mobile phase. Poly methyl methacrylate polymers is used as the calibration standard. The samples may be also subjected to differential scanning calorimetry (DSC). The midpoint Tg increases with increasing molecular weight. The Tg values, where measured, are presented in Table 2, with the GPC data.

TABLE 2
Polymer sample characterization.

| | Sample | | | | | | | | | |
|---|---|---|---|---|---|---|---|---|---|---|
| Physical Properties | 1 | 2 | 3 | 4 | 5 | 6 | 7 | 8 | 9 | 10 |
| Tg 1 midpoint (° C.) | 29 | 42.9 | 50.7 | 54.8 | 34.3 | 45.9 | 49.8 | 53 | 52 | |
| Mn (Dalton) | 2215 | 3973 | 7250 | 5302 | — | — | 19549 | 10764 | 10080 | 10469 |
| Mw (Dalton) | 2994 | 6233 | 14035 | 15391 | — | — | 31966 | 21999 | 21977 | 22487 |
| Mz (Dalton | 4042 | 9142 | 22449 | 27250 | — | — | 2.10 | 34988 | 34481 | 35118 |
| Polydispersity | 1.35 | 1.57 | 1.94 | 2.90 | — | — | 2.1 | 2.04 | 2.18 | 2.15 |

1. Mₙ is the number average molecular weight.
2. M_{w} is the weight average molecular weight.
5. M_{z} is the z-average molecular weight.

The samples are also tested using matrix-assisted laser desorption ionization (MALDI) mass spectrometry. The MALDI results show that the polymerization of the oxazolines at high temperature occurs in different ways, and that the products are structurally different in some respects that those prepared by traditional, low-temperature ROP. For example, in Scheme 1 above, it is shown that ring opening of traditional oxazoline polymerization occurs across the double bond in the oxazoline. Furthermore, end-group analysis of the polyoxazoline produced by this invention shows that the initiating and terminating group on the polymer may be somewhat different than the idealized Scheme 1 and depends to some extent upon impurities in the reactor feed. For example, the POZs prepared by the high-temperature processes may include any of the following end groups:

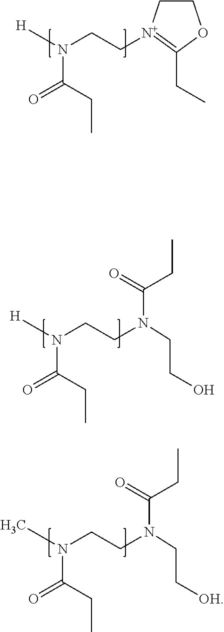

### Example 3

Viscosities of the polymer samples 2, 3, and 4 of Example 1. Samples 2, 3, and 4, from Example 1 were analyzed for rheological properties using a TA Instruments Advanced Rheology AR-2000. Oscillatory measurements were taken at an oscillatory stress of 400 dynes/cm² and a temperature ramp from to 145-205° C. at 5° C./min. The results are presented in Table 3. The Data show that the melt viscosities fall in a range applicable for hot melt adhesives.

TABLE 3
Temperature Dependent Viscosity (cps) of Samples 2, 3, and 4.

| | Sample Number (cps) | | |
|---|---|---|---|
| Temp. (° C.) | 2 | 3 | 4 |
| 145 | 11080 | 105000 | 172800 |
| 160 | 3761 | 29840 | 46280 |
| 175 | 1617 | 10870 | 16300 |
| 190 | 811 | 4774 | 6916 |

### Example 4

Ink preparation using a POZ as a dispersant. Polyoxazoline samples 5 and 6 are used in ink formulations. Samples 5 and 6 are mixed with 80:20 n-propanol:n-propyl acetate at 44.73% and 45.35% solids, respectively, to form solutions of resin in solvent. The solutions of resin in solvent are then used to prepare a pigment dispersion at a 4:1 pigment:binder ratio (=4 parts of pigment by weight to 1 part of resin solids by weight), at 20% pigment solids. The pigment is Ciba Rubine 4BL pigment. After grinding on a shaker for 4 hours with glass media, the dispersions are tested for viscosity. Only the viscosity of the dispersion is measured. Inks are prepared by adding one part dispersion to 1 part Versamid PA750 letdown and adding the solvent mixture of 80/20 wt/wt ratio of n-propanol:n-propyl acetate to adjust the viscosity of the ink. The formulations are shown n Table 4. The physical properties are presented in Table 5.

TABLE 4
Pigment formulations.

| POZ | 5 | 6 |
|---|---|---|
| Pigment (g) | 20 | 20 |
| Resin Solution | 11.18 | 11.03 |
| Solvent mix (g) | 68.82 | 68.97 |
| Total (g) | 100 | 100 |
| Solids Content (%) | 25 | 25 |

TABLE 5
Properties of the ink formulations.

| | Dispersion Viscosity (cP) | | | Ink | Color | | Tape |
|---|---|---|---|---|---|---|---|
| Sample | 3 RPM | 12 RPM | 30 RPM | NV | Density | Gloss | Adhesion |
| 5 | 17036 | 4859 | 2048 | 23.3 | 1.257 | 45.3 | 3 |
| 6 | 18796 | 4879 | 2212 | 22.81 | 1.205 | 40.9 | 3 |
| Nitro- | | | | 27.94 | 1.718 | 79.7 | 5 |
| cellulose | | | | | | | |
| (control) | | | | | | | |

Ink NV is the wt % of non-volatile material after 1 hour in oven at 150° C.
Color density is determined using an X-Rite Spectrodensitometer.
Tape adhesion is on a scale of 1 to 5, with 1 representing poor adhesion and 5 representing good adhesion.
Gloss is measured at 60°, and the unit are %.

### Example 5

In this example the polyethyloxazoline is used as a film primer for waterborne inks A waterborne ink is prepared by mixing equal parts of Flexiverse BFD-1121 blue dispersion (Sun Chemicals) with Joncryl 2621 acrylic letdown (BASF Corp). The ink is applied to corona treated polypropylene (OPP) with a 360 Anilox hand roller. The ink is dried for five seconds with a hand dryer set on high. A primer is prepared by dissolving Sample 7 from Example 1 in deionized water to form a solution of 20 wt %. This primer solution is applied with a 360 hand roller on top of the ink. This is then dried in the same manor. After the primer is dried, the OPP is heat-sealed to polyethylene coated paper board. The heat sealer is set for the top bar to be about 175° C. and the bottom bar to about 50° C. The heat sealer is set for a pressure of 40 psi and a duration time of one second. Three heat seals are made for each primer used so that results may be averaged. These primer systems are maintained overnight in a temperature and humidity controlled room. The room is maintained at 25° C. and 40-50% relative humidity. An Instron device, model 4201, may be used to pull the two substrates apart at a rate of 12 inches per minute. The average force to separate the OPP from the polyethylene coated paperboard is shown in Table 6. Comparative examples (1) without primer, (2) using a polyethylene amine primer (Lupasol P from BASF), and (3) using a commercially available polyoxazoline obtained from Aldrich (part number 372846, Mw=50,000 Daltons). Table 7 shows a significant improvement in bond strength when the prepared polyethyloxazoline, Sample 7 of Example 1, was used as a primer compared to no primer. The tests are repeated and compared to the commercially available POZ from Aldrich. The data shows comparable results compared to PEI for example 8 and superior performance in comparison to the Aldrich material.

TABLE 6
Average strength of primers heat-
sealed between OPP and paperboard

| | Test 1 | Test 2 |
|---|---|---|
| | Average strength | Average strength |
| Primer | (gram-force/cm) | (gram-force/cm) |
| No Primer | 0 | |
| Lupasol P | 21.6 | 37.5 |
| POZ solution of Sample 7 | 13.2 | 33.8 |
| Sigma Aldrich POZ | | 21.3 |

### Example 7

A polyethyloxazoline, according to Example 1, is evaluated as a hot melt adhesive on ABS (acrylonitrile butadiene styrene) and wood. Sample 7 from Example 1 is heated in an oven at 400° for approximately fifteen minutes until it melts. A layer of the melted polymer is then applied to both ABS and wood substrates. After the polymer cools below 30° C., the substrates are broken in half to determine how well the PEOX adheres. The wood substrate is also tested for adhesion by cutting a small “X” shape into the polymer with a razor blade. A piece of masking tape is applied to the “X” and ripped off quickly. The amount of polymer removed onto the masking tape is observed. The substrates are broken in half again, approximately 24 hours after, and the percentage of polymer that is removed off the substrate is observed. Table 7 illustrates that the POZ of Sample 7 adheres well to the wood and shows strong mechanical strength, as well as reasonable adhesion to ABS. Also, very little polymer is left on the masking tape during the tape test.

TABLE 7
Summary of hot melt adhesion strength

| | % PEOX Removed |
|---|---|
| Substrate | During Break |
| Wood | 20 |
| ABS | 50 |

### Equivalents

The present disclosure is not to be limited in terms of the particular embodiments described in this application. Many modifications and variations can be made without departing from its spirit and scope, as will be apparent to those skilled in the art. Functionally equivalent methods, processes and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, processes, reagents, compounds compositions or biological systems, which can of course vary. It is also to be understood that the terminology used herein is for the purpose of describing particular embodiments only, and is not intended to be limiting.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All processes described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

While certain embodiments have been illustrated and described, it should be understood that changes and modifications could be made therein in accordance with ordinary skill in the art without departing from the technology in its broader aspects as defined in the following claims.

1. A continuous process comprising polymerizing in a reactor at least one oxazoline monomer at elevated temperature to form a polyoxazoline.

2. The process of claim 1, wherein the elevated temperature is greater than 150° C.

3. The process of claim 1, wherein the reactor comprises a continuous stirred tank reactor or a series of two or more continuous stirred reactors.

4. The process of claim 1, wherein the reactor comprises a continuous loop reactor.

5. (canceled)

6. The process of claim 1, the polymerizing comprises:
feeding continuously the at least one oxazoline monomer and a catalyst to the reactor at a rate that provides for a residence time sufficient to achieve ring opening of the oxazoline and polymerize the oxazoline, wherein the reactor is maintained at a temperature from about 150° C. to about 250° C.;
exiting a polyoxazoline solution from the reactor, the polyoxazoline solution comprising polyoxazoline catalyst or catalyst fragments and, optionally, unreacted oxazoline, low molecular weight oligomeric oxazoline, or a mixture thereof.

7. The process of claim 6 further comprising feeding a solvent to the reactor with the oxazoline monomer and catalyst.

8. The process of claim 6, further comprising removing the solvent, and, optionally, unreacted oxazoline, low molecular weight oligomeric oxazoline, or a mixture thereof from the polyoxazoline solution; and recovering the polyoxazoline.

9. The process of claim 6, wherein the at least one oxazoline monomer is a compound of Formula I: 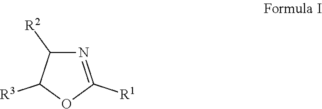
wherein:
R¹ is H, CN, NO₂, alkyl, alkenyl, aryl, heteroaryl, or heterocyclyl;
R² is H, F, Cl, Br, I, CN, NO₂, amino, alkyl, alkenyl, aryl, heteroaryl, or heterocyclyl; and
R³ is H, F, Cl, Br, I, CN, NO₂, amino, alkyl, alkenyl, aryl, heteroaryl, or heterocyclyl.

10. The process of claim 9, wherein R¹ is C₁-C₂₀ alkyl, C₁-C₂₀ alkenyl, C₆-C₁₈ aryl, or an oxazoline; R² is H, CH₃, or phenyl; and R³ is H, CH₃, or phenyl.

11. The process of claim 9, wherein the oxazoline is methyl oxazoline, ethyl oxazoline, propyl oxazoline, isopropenyl oxazoline, butyl oxazoline, phenyl oxazoline, undecyl oxazoline, dodecyl oxazoline, stearyl oxazoline, or a mixture of any two or more thereof.

12. (canceled)

13. The process of claim 6, wherein the residence time is from about 1 minute to about 1 hour.

14. (canceled)

15. The process of claim 6, wherein the catalyst is a weak Lewis acid, a strong protic acid, an alkyhalide a benzyl halide, a substituted benzyl halide, a strong acid ester, or a mixture of any two or more thereof.

16. The process of claim 6, wherein the catalyst comprises methyl-p-toluene sulfonic acid, a salt of methyl-p-toluene sulfonic acid, BiCl₃, BiBr₃, BiI₃, bismuth triflate, methyl triflate, benzyl chloride, benzyl iodide, or benzyl bromide.

17. The process of claim 6, wherein the temperature is from about 180° C. to about 220° C.

18. (canceled)

19. (canceled)

20. The process of claim 6, wherein a yield of polyoxazoline is greater than 90%.

21. (canceled)

22. (canceled)

23. The process of claim 6, wherein the oxazoline, solvent, and catalyst are fed separately to the reactor.

24. The process of claim 6 further comprising dissolving the oxazoline in the solvent prior to feeding.

25. The process of claim 6 further comprising dissolving the oxazoline and catalyst in the solvent prior to feeding.

26. (canceled)

27. The process of claim 1, wherein the polyoxazoline is a co-polymer comprising the polymerization product of the two or more oxazoline monomers.

28. The process of claim 1, wherein the polymerizing comprises alternating polymerizations of the oxazoline monomer and a second oxazoline monomer, and the polyoxazoline is a block co-polymer of the oxazoline monomer and the second monomer.

29. The process of claim 28, wherein the second oxazoline monomer comprises methyl oxazoline, ethyl oxazoline, propyl oxazoline, isopropenyl oxazoline, butyl oxazoline, phenyl oxazoline, undecyl oxazoline, dodecyl oxazoline, or stearyl oxazoline.

30. (canceled)

31. (canceled)

32. The polyoxazoline produced by the process of claim 1.
